(19) United States
(12) Patent Application Publication
(10) Pub. No.: US 2026/0005332 A1
(43) Pub. Date: Jan. 1, 2026

(54) INSULATING AND COOLING ASSEMBLY FOR A BATTERY CELL

(71) Applicant: PLASTIC OMNIUM E-POWER GMBH, Salzgitter (DE)

(72) Inventors: Heinz-Peter BAUMGARTE, Baiersdorf (DE); Wilhelm BURG, Bamberg (DE); Frank GAJEWSKI, Braunschweig (DE); Martin GLINKA, Buckenhof (DE); Tony JAUMANN, Leinburg (DE); Dietmar KUNST, Bad Harzburg (DE); Cornelia MAGER, Dormitz (DE); Fabian QUAST, Erlangen (DE); Mathias Wesley SCHENKEL, Nürnberg (DE); Christoph SCHNEIDER, Nordhausen (DE)

(73) Assignee: PLASTIC OMNIUM E-POWER GMBH, Salzgitter (DE)

(21) Appl. No.: 18/868,368

(22) PCT Filed: May 26, 2023
(86) PCT No.: PCT/EP2023/064214

§ 371 Date: Nov. 22, 2024

(30) Foreign Application Priority Data
May 31, 2022 (DE) 10 2022 205 551.9

(51) Int. Cl. H01M 10/6555; H01M 10/613; H01M 10/653; H01M 10/6557; H01M 10/6567

(52) U.S. Cl. CPC H01M 10/6555; H01M 10/613; H01M 10/653; H01M 10/6557; H01M 10/6567; H01M 2220/20

(57) ABSTRACT

An insulating and cooling assembly for at least one battery cell includes: at least one cooling plate with a first main side for thermal contact with the at least one battery cell, and with a first and an opposing second end side, and including an insulating element for electrical insulation on a first end side of the cooling plate. A first side surface of the insulating element lies substantially in the same plane as the first main side of the cooling plate.

The invention relates to an insulating and cooling assembly for a battery cell and a battery cell assembly with an insulating and cooling assembly, which is used in particular in traction batteries.

In many technical fields, the term battery has also become established for accumulators and is used as such in the present application. This applies in particular to applications in vehicles and aircraft, for example cars or rail vehicles.

These use traction batteries which must be cooled to ensure their performance and sufficient service life. Various designs for the battery cells of such batteries are known, in particular prismatic, cylindrical and pouch cells. For cooling, water-cooled cooling plates that consist of aluminum alloys are usually used for high performance requirements. By connecting the battery cells in series, the desired voltage is achieved, which for traction batteries is in the kV range. A sufficiently good insulation against the cooling system must be ensured, otherwise short circuits and destruction of the battery will occur. In addition, a compact and light design of the traction battery is required, while at the same time high mechanical and environmental requirements over a long service life must be met.

Reliable insulation of the battery cells from the cooling plates is also made more difficult in a design that is as compact as possible by the fact that if leakage currents occur via air and creepage distances, the affected components of the system are difficult to access. Furthermore, from a physical point of view, the insulating properties of materials are usually in contrast to mechanical flexibility and good thermal conductivity, the latter being necessary for transferring the heat from the battery cells to the cooling plates.

It is known to stick a thin insulating film such as Kapton or polyester onto the battery cells. However, these are mechanically very sensitive, and their small thickness means there is a risk of partial discharges. Insulation is often inadequate at corners and edges. The same applies to silicone-based films with or without glass fiber reinforcement. Although tolerance compensation (i.e. compensation of manufacturing tolerances in the battery components) is possible depending on the hardness of the utilized material, this material is also difficult to apply over corners and edges, and the edges of the insulation are critical with regard to air and creepage distances.

An insulating coating may also be applied to the cooling surfaces. It is difficult to ensure a long-term good adhesion to the surface, and cracks, pores or detachments pose a risk, as do corners, edges and holes. Tolerance compensation is not possible.

Finally, it is also known to only implement low-voltage insulation in the battery region and to move high-voltage insulation to other locations, for example between load-bearing components and the vehicle housing. However, this is associated with a complex construction, as both the coolant and the connection points (load-bearing component to the vehicle housing) must be durable and highly insulating under all conditions. Sufficient insulation can therefore often not be achieved.

The object of the invention is to provide a cooling assembly for a battery cell which allows good cooling and at the same time reliable insulation.

This object is achieved by an insulating and cooling assembly as well as by a battery cell assembly having the respective features of the independent claims. Advantageous embodiments of the invention are specified in the respective dependent claims.

A first aspect of the invention relates to an insulating and cooling assembly for at least one battery cell, comprising at least one cooling plate with a first main side for thermal contact with the at least one battery cell, and with a first and an opposing second end side, and comprising an insulating element for electrical insulation on a first end side of the cooling plate, wherein a first side surface of the insulating element lies substantially in the same plane as the first main side of the cooling plate.

The invention provides for an insulating element to be provided on a first end side of a cooling element, the side surface of which lies substantially in the same plane as a side surface of the cooling plate. This is the side surface of the cooling plate that is intended for thermal contact with a battery cell and that is referred to as the first main side. The insulating element effectively enlarges the first main side of the cooling plate beyond its first end side. Because the side surfaces lie substantially in the same plane, there is a substantially flat base for an insulating layer so that it does not have to be guided around an edge or corner. Possible creepage distances to the cooling plate are significantly increased, and the insulation is also thereby improved. The term cooling plate comprises different shapes of cooling devices and not only plate-shaped structures in the narrower sense; in particular, the side surfaces do not have to be strictly flat. Preferably, a coolant such as water flows through the cooling plate.

A second aspect of the invention relates to a battery cell assembly with at least one battery cell and an insulating and cooling assembly according to the invention, wherein a first main side of the battery cell is in thermal contact with the first main side of the cooling plate (4), and an insulating layer is arranged between these first main sides, and wherein the insulating layer extends over substantially the entire first main side of the cooling plate and substantially the entire first side surface of the insulating element.

The invention thus also comprises a battery cell assembly with one or more battery cells and the insulating and cooling assembly. A first main side of the battery cell is in thermal contact with the first main side of the insulating and cooling assembly. An insulating layer is arranged between the first main side of the cooling plate and the first main side of the battery cell, which has sufficient electrical insulation properties and at the same time sufficient thermal conductivity. The insulating layer extends over substantially the entire first main side of the cooling plate and over at least a part of the first side surface of the insulating element. Because the side surfaces of the cooling plate and insulating element lie substantially in same plane, the insulating layer is applied to a flat surface, which is simple in terms of manufacturing and reduces the risk of weak points or damage. Furthermore, a certain tolerance compensation can be made.

The battery cell may have a conventional design type. In particular, it may be a prismatic cell, a pouch cell or a cylindrical cell.

According to one embodiment, a first end side of the battery cell lies substantially in the same plane as the first end side of the cooling plate. In other words, these parts are “the same height”, and the insulating element extends beyond them. Alternatively, the first end side of the cooling plate may lie higher or lower than the end side of the battery cell, with cooling being improved in the first case (larger cooling plate). With a smaller cooling plate, if the first end side of the cooling plate lies lower than the end side of the battery cell, the space requirement can be reduced. It is possible, for example, that the side of the insulating element facing away from the cooling plate lies in the same plane as the first end side of the battery cell so that the insulating element does not extend beyond the battery cell, and a particularly compact assembly is achieved.

The insulating layer preferably covers the entire first side surface of the insulating element, but it may also leave a part free if sufficient insulation is ensured in the region of the first end side of the cooling plate.

The insulating element may be at least partially covered with an electrically insulating fastening element. The fastening element may be used in particular to fasten the insulating element to the cooling plate and/or to sufficiently fix the battery cell. The fastening element may at least partially cover the battery cell, thereby achieving fixation in the corresponding direction. The fastening element can, for example, be connected to the insulating element as a result of its shape, in particular by means of a toothing or interlocking, or a screw connection can be provided.

The first end side of the cooling plate may be flat, but it may also have a bulge or a projection which extends into the insulating element. This improves the insulating effect.

An additional insulating element may be present on a second end side of the cooling plate opposite the first end side, wherein its first side surface also lies substantially in the same plane as the first main side of the cooling plate. The advantageous effects also occur here, since the insulating layer is applied on a substantially smooth surface, and it is not necessary to guide the insulating layer around corners or edges for good insulation. In the case of minor deviations from a completely smooth surface, for example due to manufacturing tolerances, the insulating layer can provide the necessary compensation.

In principle, the same variants are possible for the additional insulating element as for the insulating element. It is particularly advantageous if the additional insulating element also forms a holder or support for the battery cell or for the battery cell adjacent thereto. Depending on the assembly of the battery cells, the battery cell adjacent to the additional insulating element may be different from the battery cell adjacent to the insulating element. The additional insulating element may have a T-shaped or angular cross section and extend at least partially under the adjacent battery cell. Furthermore, the second end side of the cooling plate may have a bulge or a projection as described in connection with the first end side.

In general, a plurality of battery cells, referred to here as a module, are arranged between two insulating and cooling assemblies and interconnected with each other in the desired manner to generate the required voltage and current. The geometric assembly of the battery cells in the module depends on the design type of battery cells. Preferably, a plurality of such modules is arranged next to one another, with an insulating and cooling assembly being present between two modules, and these quasi-internal insulating and cooling assemblies also having an insulating layer on a second main side opposite the first main side. Preferably, the internal insulating and cooling assemblies are constructed symmetrically.

A thermoconductive structure may be present between some or all of the battery cells of a module. Said thermoconductive structure is preferably thermally and electrically conductive, wherein the electrical conductivity can be used in particular for interconnecting the battery cells.

Particularly preferably, the battery cell assembly is designed as a traction battery of a vehicle, in particular a rail vehicle.

The invention is explained in more detail below with reference to embodiments. The drawings schematically show:

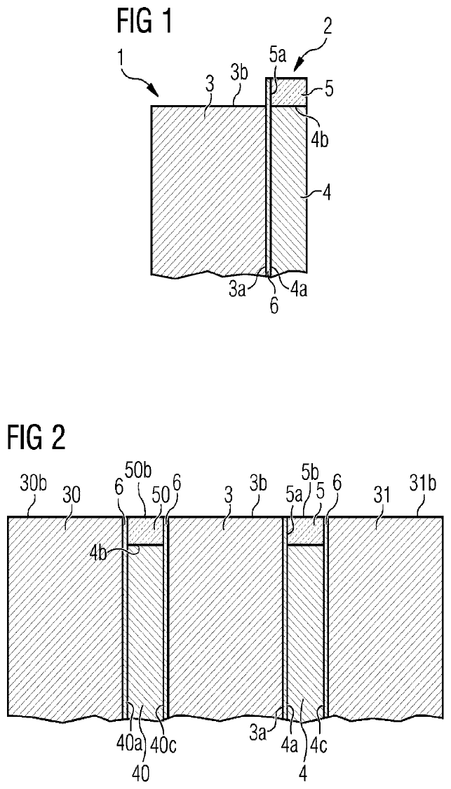

FIG. 1 a first embodiment of a battery cell assembly according to the invention with an insulating and cooling assembly according to the invention,

FIG. 2 an arrangement with a plurality of battery cell assemblies of a second embodiment,

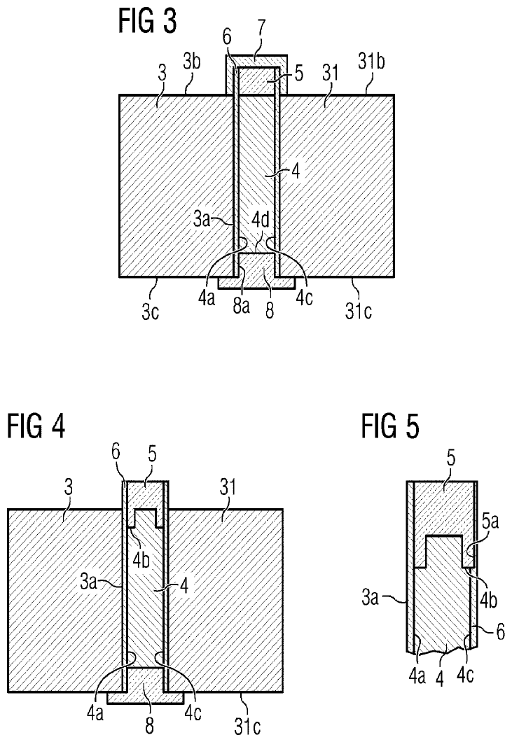

FIG. 3 a third embodiment,

FIG. 4 a fourth embodiment,

FIG. 5 a part of the insulating and cooling element of the fourth embodiment with a tolerance compensation,

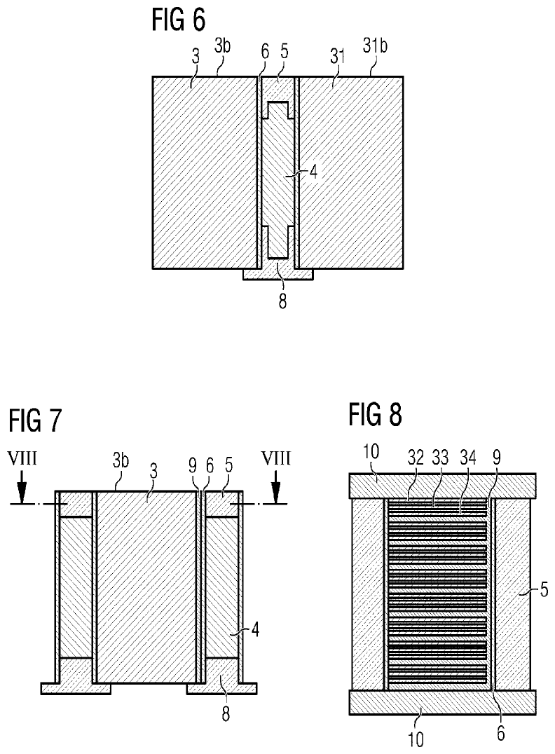

FIG. 6 a fifth embodiment,

FIGS. 7 and 8 a sixth embodiment, and

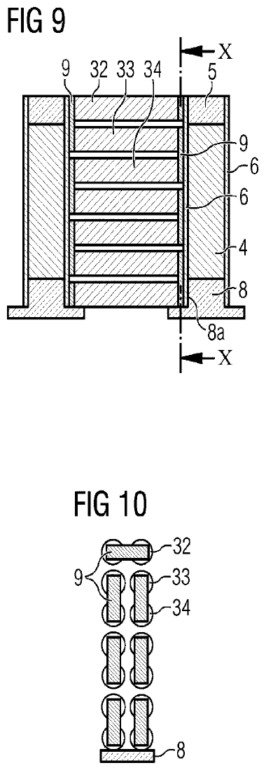

FIGS. 9 and 10 a seventh embodiment.

The figures each show a cross section, but for reasons of clarity, the internal structure of the individual components such as the cooling plate and battery cell is not shown.

FIG. 1 shows a first embodiment of a battery cell assembly 1 with an insulating and cooling assembly 2 and a battery cell 3. The insulating and cooling assembly 2 comprises a cooling plate 4 with a first main side 4a and a first end side 4b. An insulating element 5 that has a first side surface 5a is arranged on the first end side 4b. The first side surface 5a and the first main side 4a lie in the same plane so that a continuous smooth support surface for an insulating layer 6 is formed here. The insulating layer 6 extends over the entire first main surface 4a of the cooling plate and over the entire first side surface 5a of the insulating element. The battery cell 3 is electrically insulated from the cooling plate on its first main side 3a by the insulating layer 6, but thermally connected. For the insulating layer, for example, a glass fiber reinforced silicone material, e.g. with ceramic filler for better thermal conductivity, with a thickness in the range of 0.1 mm-5 mm can be used, or another material used in the state of the art, such as Kapton or polyester. A combination of such a glass fiber reinforced silicone material with a cross-linking, initially liquid silicone material is also possible.

In this embodiment, a first end side 3b of the battery cell lies in the same plane as the first end side 4b of the cooling plate. The first end sides 3b, 4b may also lie in different planes.

Typically, a plurality of battery cells is arranged one behind the other, i.e. in front of or behind the plane of the drawing, and are suitably interconnected to form a module. The insulating and cooling assembly then extends accordingly over the length of the module in front of and behind the plane of the drawing. In this embodiment, a prismatic battery cell is provided.

FIG. 2 shows battery cell assemblies lying next to one another with battery cells 3, 30, 31 and insulating and cooling assemblies with cooling plates 4, 40 and insulating elements 5, 50 in between. The insulating layer 6 is applied to or arranged on the first main side 4a, 40a of the cooling plates and on the opposing second main side 4c, 40c. The insulating layer 6 may have a greater length in each case, wherein the length extending beyond the respective first end side 3b, 30b, 31b of the battery cells 3, 30, 31 or beyond the respective insulating element 5, 50 can be transferred to the adjacent battery cell or the insulating element. Even if damage should occur in this region, the creepage distance will not be shortened thereby as this is still guaranteed by the insulating element. In this embodiment, the side 5b, 50b of the insulating element 5, 50 facing away from the cooling plate lies in the same plane as the first end side 3b, 30b, 31b of the battery cells. The same height results in a particularly space-saving design. It is expedient to provide an additional insulating element in the same way on the side opposite the first end side 4b of the cooling plate, i.e. the cooling plate 4 is correspondingly shorter, and the additional insulating element lies in the same plane as the underside of the battery cell. This results overall in a highly space-saving design while at the same time providing very reliable electrical insulation.

FIG. 3 shows a third embodiment in which the insulating element 5 is covered with an electrically insulating fastening element 7. The fastening element 7 also extends over the insulating layer 6 and part of the adjacent battery cells 3, 31. The battery cells are fixed in this way. Fixation or support in the opposite direction is achieved by an additional insulating element 8 on the second end side 4d of the cooling plate, which is opposite the first end side. This additional insulating element 8 has a T-shaped cross section and extends partially under the adjacent battery cells, i.e. under a second end side 3c, 31c which is opposite the first end side 3a. Its side surfaces lie in the same plane as the first or second main side 4a, 4c of the insulating and cooling assembly. In one variant, the additional insulating element 8 may have a rectangular cross section, i.e. it does not extend under the adjacent battery cells and does not serve for fixation or support. Preferably, it then ends with the second end side 3c, 31c, as already explained in the description of FIG. 2. The fastening element 7 can be connected to the insulating element 5 and, if applicable, the cooling plate, for example by means of a screw connection. The insulating element 5 and the fastening element 7 may also be shaped in such a way that they are connected to one another by interlocking. In the third embodiment, the insulation is also improved in the lower region of the battery cell by the additional insulating element 8, since possible creepage distances are significantly extended. The lower insulating element can be coated only with an insulating material, and its core can consist of another material, for example a thermally conductive material and preferably the material of the cooling plate.

FIG. 4: In this embodiment, the first end side 4b of the cooling element has a projection which extends into the insulating element 5. This allows the cooling plate 4 to be enlarged almost without reducing the insulating effect.

FIG. 5 shows the upper part of the insulating and cooling assembly in the case that the first or second main side 4a, 4c of the cooling plate 4 and the corresponding side surface 5a of the insulating element 5 do not lie completely in the same plane. The small step that occurs can be compensated for by the insulating layer 6 if an insulating layer 6 with sufficiently plastic properties is selected.

FIG. 6 shows an embodiment in which a projection of the cooling plate 4 extends into the additional insulating element 8, and the insulating element 5 ends at the top with the first end side 3b, 31b of the battery cell. These measures achieve a very good insulating and cooling effect with a compact design at the same time. It is also possible for the cooling plate to extend even further into the additional insulating element and also under the battery cell, with the additional insulating element partially encasing the cooling plate here. This can be advantageous for stability since the cooling plate 4 is usually made of an electrically conductive metal. Such a casing is preferably provided at those locations where an extension of the creepage distance is required. This can be the case, for example, at the interfaces between the insulating element 8, the insulating layer 6 and the battery cell 3, 31.

FIGS. 7 and 8 show an embodiment with battery cells 3, 32, 33, 34, wherein FIG. 8 shows a cross section in the plane shown in dashed lines in FIG. 7, i.e. at the level of the insulating element 5. In FIG. 8, the battery cells 32, 33, 34 lying one behind the other can be seen, which are designed as pouch cells. For better heat dissipation, a thermoconductive structure 9 is inserted after every three cells, for example, which extends on one side, the right side in FIG. 8, to the insulating layer 6 and can be connected here so that it has a comb-shaped or repeating L-shaped structure. The thermoconductive structure 9 can also extend in sections alternately on one side and the other side up to the insulating layer, i.e. the repeating L-shaped structures are each stacked in a mirror image to the one below. Cover plates 10 are provided at the front and rear ends of the module as a closure. If these cover plates 10 are made of an electrically conductive material, they must additionally be electrically insulated from the battery cell 32 or the thermoconductive structure 9 adjacent to the respective cover plate 10. For this purpose, plates or blocks made of an electrically insulating material may be provided which, according to the example in FIG. 8, are arranged above the upper battery cell 32 or below the lower prong of the thermoconductive structure 9. The plates or blocks have a thickness corresponding to the required extension of the creepage distance.

FIGS. 9 and 10 show an embodiment with cylindrical cells, wherein FIG. 10 shows a cross section in the plane shown in dashed lines in FIG. 9, i.e. parallel and closely adjacent to the insulating layer 6. The battery cells 32, 33, 34 are arranged horizontally and suitably connected at their poles by means of the electrically conductive thermoconductive structure; in the example, fourteen cells are connected in series, as can be seen in FIG. 10. The thermoconductive structure 9 also serves to thermally connect to the insulating layer 6 on both sides of the module. The cooling plates 4 border on the insulating element 5 and the additional insulating element 8. The first side surfaces 5a, 8a of the insulating elements 5, 8 and the first main side 4a of the cooling plate lie in the same plane so that the insulating layer 6 does not have to be guided around edges or corners.

The features and aspects of the invention described in the embodiments can of course be combined with one another in different ways. In particular, the features can be used not only in the described combinations, but also in other combinations or on their own.

### LIST OF REFERENCE SIGNS

1 Battery cell assembly
2 Insulating and cooling assembly
3, 30, 31, 32, 33, 34 Battery cell
3a First main side of the battery cell
3b First end side of the battery cell
3c Second end side of the battery cell
4, 40 Cooling plate
4a, 40a First main side of the cooling plate
4b First end side of the cooling plate
4c, 40c Second main side of the cooling plate
4d Second end side of the cooling plate
5 Insulating element
5a First side surface of the insulating element
5b Remote side surface of the insulating element
6 Insulating layer
7 Fastening element
8 Additional insulating element
8a First side surface of the additional insulating element
9 Thermoconductive structure
10 Cover plate

1-11. (canceled)

12. An insulating and cooling assembly for at least two battery cells, comprising at least:
one cooling plate with a first main side for thermal contact with the one battery cell, with a second main side opposite the first main side for thermal contact with the second battery cell, and with a first and an opposing second end side; and
an insulating element for electrical insulation on a first end side of the cooling plate,
wherein a first side surface of the insulating element lies substantially in the same plane as the first main side of the cooling plate.

13. The insulating and cooling assembly according to claim 12, further comprising an insulating layer for electrical insulation, which is applied to the first main side of the cooling plate and at least a part of the first side surface of the insulating element.

14. A battery cell assembly with at least one battery cell and an insulating and cooling assembly according to claim 13,
wherein a first main side of the battery cell is in thermal contact with the first main side of the cooling plate, and the insulating layer is arranged between these first main sides, and
wherein the insulating layer extends over substantially the entire first main side of the cooling plate and at least a part of the first side surface of the insulating element.

15. The battery cell assembly according to claim 14, wherein a first end side of the battery cell lies substantially in the same plane as the first end side of the cooling plate or as the side of the insulating element facing way from the cooling plate.

16. The battery cell assembly according to claim 14, wherein the insulating element is at least partially covered with an electrically insulating fastening element, wherein the insulating fastening element fixes the battery cell.

17. The battery cell assembly according to claim 14, wherein the first end side of the cooling plate has a bulge or a projection which extends into the insulating element.

18. The battery cell assembly according to claim 14, wherein an additional insulating element is arranged on the second end side of the cooling plate, wherein a side surface of the additional insulating element lies substantially in the same plane as the first main side of the cooling plate.

19. The battery cell assembly according to claim 18, wherein the further insulating element has a T-shaped or angled cross section and extends at least partially under the second end side of the battery cell opposite the first end side.

20. The battery cell assembly according to claim 19, wherein the additional insulating element consists of a thermally conductive material and is at least partially coated with an insulating material for electrical insulation.

21. The battery cell assembly according to claim 14, wherein a thermoconductive structure is arranged between two battery cells and/or between the battery cell and the insulating layer.
